(19) United States
(12) Patent Application Publication
(10) Pub. No.: US 2012/0196039 A1
(43) Pub. Date: Aug. 2, 2012

(54) METHOD FOR ENHANCING METALLIZATION IN SELECTIVE DEPOSITION PROCESSES

(75) Inventors: Muhammad Iraqi, Tira (IL); Avi Levy, Mitzpe Aviv (IL); Eva Igner, Haifa (IL)

(73) Assignee: CAMTEK LTD., Migdal Haemek (IL)

(21) Appl. No.: 13/346,748

(22) Filed: Jan. 10, 2012

Related U.S. Application Data
(60) Provisional application No. 61/437,720, filed on Jan. 31, 2011.

(51) Int. Cl. B05D 5/00; B08B 3/08; B08B 3/12; B05C 9/12; B08B 7/00

(52) U.S. Cl. 427/282; 118/75; 134/42; 134/1

(57) ABSTRACT

A method for achieving a clean substrate, the method may include depositing a protective material on an area of a substrate, to prevent the area from being contaminated by a coating material that is to be deposited during a deposition process; and removing the protective material from the area after the coating material was cured.

### RELATED APPLICATIONS

This application claims the priority of U.S. provisional patent 61/437720 filing date Jan. 31 2011, which is incorporated herein by reference.

### BACKGROUND

Printing and coating are examples of depositing processes. A selective deposition process includes depositing a material at some desired points of an article and leaving some other points free of this material.

When selective coating or printing is performed on a roughened surface, some components of the deposited material may flow to the un-coated/un-printed areas due to capillary forces. This unwanted flow, referred to as“halo” hereafter, may influence later processes as it contaminates material uncoated surfaces.

The extent of the halo effect depends on the texture and roughness of the surface and the characteristics of the coating material.

One example of a process that can be affected by the halo is etching resist printing. If halo exists in the rim of the printed etch resist material, it may interfere with the etching process, adding or removing features and thereby introducing defects.

One other example of a process in PCB manufacturing that can be affected by the halo is solder mask printing, the halo effect in the rim of the printed solder mask material may interfere with the following processes such as surface coating thereafter of the remaining pads.

One other example of a process that can be affected by the halo is selective painting/coating, were a halo generated during a printing of one layer may affect the printing process of other layers.

For coating processes performed in the Printed Circuit Board (PCB) fabrication such as Electroless Nickel Immersion Gold (ENIG), Tin Immersion and Immersion Silver, the halo effect appears during solder mask application and may cause adhesion problems. An example of such phenomena will be described in more details below.

Over the past ten years, coatings of electroless nickel (4-6μ) and immersion gold (0.05-0.10μ) have become the preferred surface finishes for high reliability applications involving complex circuit designs. Commonly referred to as ENIG, the electroless nickel immersion gold finish has gained market share due to its versatility in a wide range of component assembly methods including solder fusing, wave soldering, and wire bonding.

The Electroless Nickel Immersion Gold (ENIG) provides a highly solderable flat surface that does not tarnish or discolor, enhances long shelf life. The Nickel serves as barrier against copper diffusion and prevents copper contamination of the solder during soldering and rework operations. The finish also provides EMI shielding properties to the assembly.

During the manufacturing process, one or more layers of solder mask are printed on the printed circuit board. ENIG or other finishes are then applied to the areas not covered by the solder mask, where nickel and gold are plated.

The solder mask, especially when printed with zero clearance (such that it is in close contact to areas on the copper that are not supposed to be covered by it) contaminates the chemically etched copper by flowing because of capillary forces forming the “halo”. This contaminating halo interferes with the following surface finishing processes and has the potential to weaken the bond between the copper and the nickel and gold layers and may even prevent the nickel and gold layers from being coated on to the copper. The extent of halo penetration depends on the roughness and texture of the etched copper surface and on the characteristics of the chemical components of the solder mask. It is important to achieve clean copper surfaces prior to electroless plating, so such contamination has to be avoided or, alternatively, if impossible to avoid, must be effectively removed before the electroless process is initiated.

### SUMMARY

There are provided methods and systems as illustrated in the specification and the claims.

### BRIEF DESCRIPTION OF THE DRAWINGS

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

FIGS. 1-2 illustrate methods according to various embodiments of the invention;

FIGS. 3A-3D illustrate a copper pad and various portions according to various embodiments of the invention; and

FIG. 4 illustrates a system according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The term depositing process will include printing and coating. The terms printing and coating are used interchangeably throughout the disclosure.

Various examples can refer to a copper that should be protected and to processes such as ENIG that may follow the deposition of a protective material. It should be noted that the various methods and systems are not limited to copper and are not associated only with ENIG.

The terms material and materials are used interchangeably throughout the disclosure.

The term coating material refers to a material that may appear on areas that are required to be coated with a finishing process, such as ENIG. This contamination is caused by the halo effect.

Various methods are provided for preventing or removing the contamination (for example- prevention of the formation of a halo) on an area of a substrate such as a PCB. The contamination may include the formation of contaminants at areas that should not be coated by the coating material.

These methods may include (a) coating an area of a substrate with a protective material that will prevent the contamination, and (b) applying a cleaning process to remove the contaminants from the area without damaging it.

The first method may include selective coating of areas that need to be protected from contamination. Such protection may be achieved by applying a protective material that will not allow the penetration of the coating material to be deposited.

The first method may include making an area hydrophobic by printing a protective material that will cause the area to become hydrophobic. For example, a copper area that should be surrounded by solder mask but should be clear from solder mask can be made hydrophobic before performing a solder mask deposition process. The copper area can be made hydrophobic by printing on the copper area contamination preventing material such as a fatty acid, or alcohol, or a mixture of fatty acid and alcohol.

The first method can also be followed by removing the protective material especially after the coating material is printed and cured.

Such a method can also be used in applications where the coating material deposition process may form a mask or another pattern. For example, when a target area has to be selectively coated by a coating material that does not poses qualities of being selectively and accurately applied on the target area. In such cases, the protective material can be deposited to form a mask (on so-called protected areas) before the material deposition process deposits the coating material.

The inability of the material deposition process to accurately form the mask or the pattern of the coating material may be attributed to various reasons such as due to one or more characteristics of the target area to be coated, one or more characteristics of the coating material such as (but not limited to) incompatibility of area energies, the roughness of the target area, the viscosity of the coating material, whereby the coating material or part of its components may flow uncontrollably over the target area, thereby contaminating unwanted regions.

The protective material may be selected such as to enable an accurate printing of the protective material. Such method can also be used in applications where the protective coating may act as a mask. For example, when a surface has to be selectively coated by a material that does not poses qualities of being selectively and accurately applied. In such cases, a mask having the proper qualities to be accurately placed on the material to be coated without flowing or contaminating unwanted regions, can be applied using the said method, creating a protective coating. The coating material can then be globally applied and will coat only the unprotected areas. Following this step, the protective material can be removed.

A possible such instance is the application of etch resist on metallic surfaces that have to be selectively etched by another material. Two possible examples are:

a. The etch resist is the material that is accurately placed, and the etching agent is the material that cannot be accurately placed over the areas to be etched. The etch resist that is accurately placed in a first step, is removed after the entire surface is further wetted by the etching agent and has performed its task.

b. The etch resist is the material that has to be accurately placed, but for various reasons this is not possible and may generate a contamination halo. In this case, a material that can be accurately placed but that does not poses the characteristics to resist the etching process is accurately printed. Then, the etch resist material is printed using any of the possible methods. The first protective cover is removed and now the etching process can proceed.

The protective cover can be applied using accurate methods such as but not limited to ink-jet. The protective layer can be applied by any method whether accurate such as but not limited to ink-jet, or inaccurate such as but not limited to curtain coating. The protective material can be paraffin, or other hot melt compounds.

After the protective material is deposited the coating material can be deposited without flowing or contaminating unwanted areas. After the coating material is cured the protective material can be removed.

The protective material can be an etch resist material that is deposited on a substrate before etching. The etch resists material can be accurately deposited on one or more protected areas to form a mask. The deposition is followed by printing the etching agent on the target areas and on the protected areas, completing the etching process, removing the etch agent material and finally removing the etch resist material.

The protective material can be deposited using digital printing technologies such as ink jetting. The coated material can be deposited by accurate or non-accurate deposition processes such as ink-jetting, screen coating and the like.

According to an embodiment of the invention the area to be protected by deposition of the protective material can be an area that is expected to be contaminated, peripheries of such an area, or an area that includes portions that are expected to include contaminants and portions that are not expected to include contaminants. For example, a copper pad may be expected to be fully protected even when the solder mask ink is expected to contaminate only portions of that copper pad.

An area to be protected can be made hydrophobic by a mixture of fatty acid (like oleic acid) and alcohol (isopropyl alcohol) prior to the printing of the solder mask. The mixture can include material that will prevent the solder mask to attach to the copper.

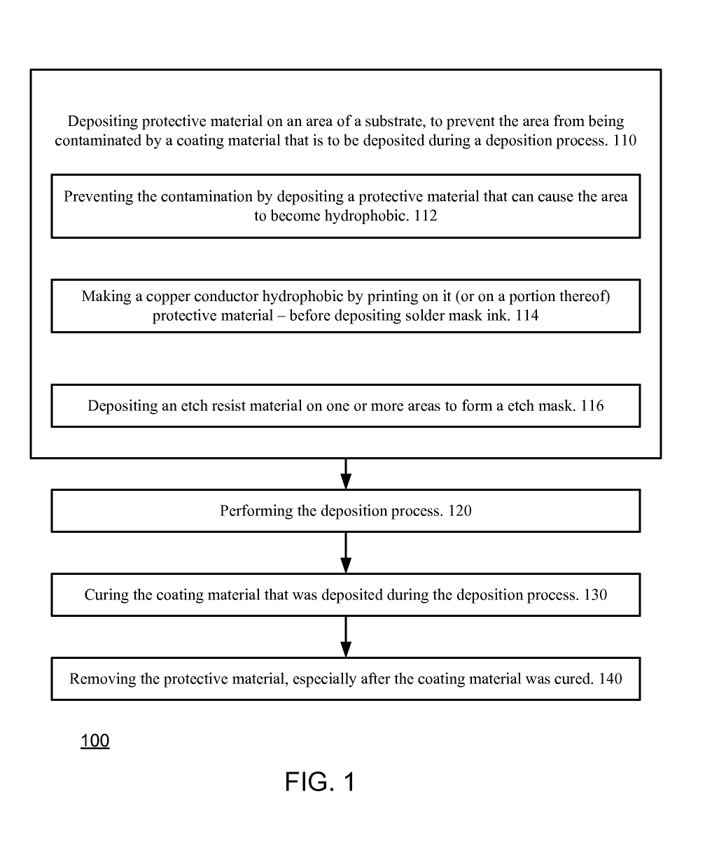

FIG. 1 illustrates method 100 according to an embodiment of the invention.

Method 100 starts by stage 110 of depositing protective material on an area of a substrate, to prevent the area from being contaminated by a coating material that is to be deposited during a deposition process and can be potentially contaminating.

The area to be protected by the protective material can be the exact area that is expected to be contaminated, peripheries of such an area or an area that include portions that are expected to include contaminants and portions that are not expected to include contaminants. For example, a copper pad may be expected to be fully protected even when the solder mask ink is expected to contaminate only portions of that copper pad.

The coating material can be a water based material and stage 110 may include stage 112 of preventing the contamination by depositing a protective material that causes the area to become hydrophobic.

Stage 110 may include depositing protective materials such as fatty acid, or a mixture of fatty acid and alcohol (such as isopropyl alcohol) on the area to be protected.

Stage 110 may include stage 114 of making a copper conductor hydrophobic by printing on it (or on a portion thereof) protective material—before depositing solder mask (potentially contaminant) ink.

Stage 110 may include stage 116 of depositing an etch resist material on one or more areas to form a protective coating.

Stage 110 may be followed by stage 140 of removing the protective material, especially after the coating material was cured. Stage 140 can include removing a protective material such as fatty acid, using a mixture of water and Ethanol.

Stage 140 is executed after the coating process ends and the coating material is cured. The deposition process and, additionally or alternatively, the curing of the coating material can be a part of method 100, as illustrated by stages 120 of performing a deposition process and stage 130 of curing the coating material that was deposited during the deposition process.

Stage 120 may include forming a solder mask, forming a solder ink pattern, supplying an etching agent, or any other selective deposition process.

According to another embodiment of the invention, a method can be provided and can include removing contaminants, especially after the coating material is cured.

The method can include placing a substrate that was contaminated within a tank that is filled with fluid and using ultrasonic energy to remove the contaminants.

Such removal is achieved by cleaning the whole substrate (after the coating material deposition) with chemicals such as but not limited to an alkaline solution in a ultrasonic cleaner.

Naturally, the cleaning material and any cleaning device used for this cleaning are chosen and preset so as to remove the extraneous material only from the areas that should be clean of the coating material without damaging the desired results of the coating process.

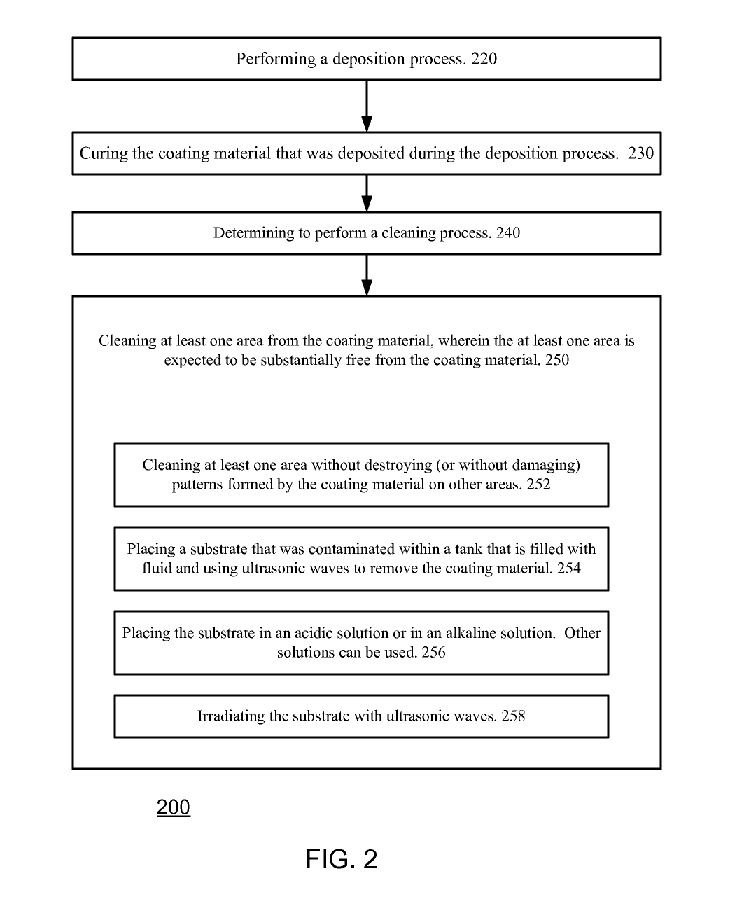

FIG. 2 illustrates a method 200 according to another embodiment of the invention.

Method 200 may start by stage 240 of determining to perform a cleaning process. This stage may include determining that a coating material that was deposited during a coating deposition process was cured—at least at areas that should be cleaned from the coating material.

Stage 240 may be followed by stage 250 of cleaning at least one area from the coating material, wherein the at least one area is expected to be substantially free from the coating material.

It is essential that the patterns formed by the coating material on other areas should withstand the cleaning process. In this case stage 250 can include stage 252 of cleaning at least one area without destroying (or without damaging) patterns formed by the coating material on other areas. Stage 250 may include stage 254 of placing a substrate that was contaminated within a tank that is filled with fluid and using ultrasonic waves to remove the coating material (remove the contaminants).

Stage 250 may include stage 256 of placing the substrate in an acidic solution or in an alkaline solution. Other solutions can be used.

Stage 250 may include stage 258 of cleaning the substrate with ultrasonic cleaning equipment.

Stage 250 may include any combination of stages 252, 254, 256 and 258.

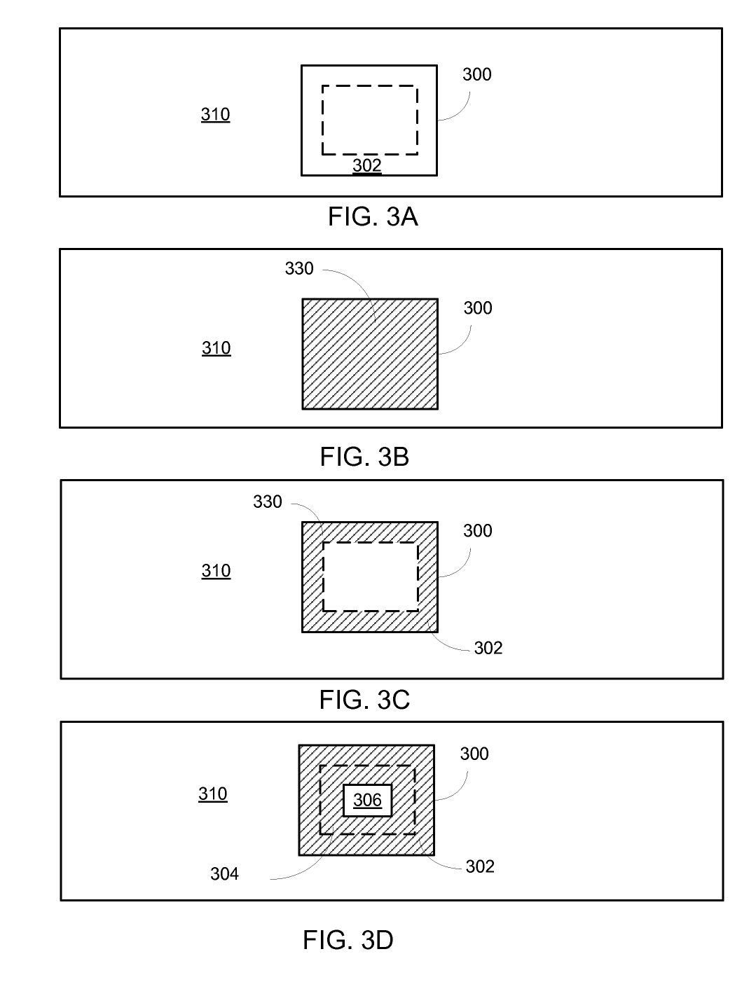

FIGS. 3A-3C illustrates a copper pad 300 and various areas according to an embodiment of the invention.

FIG. 3A illustrates a copper pad 300 that is at least partially surrounded by substrate 310 that should be covered with solder mask ink.

It is expected that during the deposition of the solder mask ink a first portion 302 of the copper pad is expected to be affected by the halo effect.

FIG. 3B illustrates a deposition process that coats the entire pad 300 with protective material 330.

FIG. 3C illustrates a deposition process that coats only the first portion 302 of the copper pad 300 with protective material 330.

FIG. 3D illustrates a deposition process that coats the first portion 302 of the copper pad 300 and an additional portion 304 of the copper pad with protective material 330 while maintaining a further portion 306 of the copper pad free of the protective material.

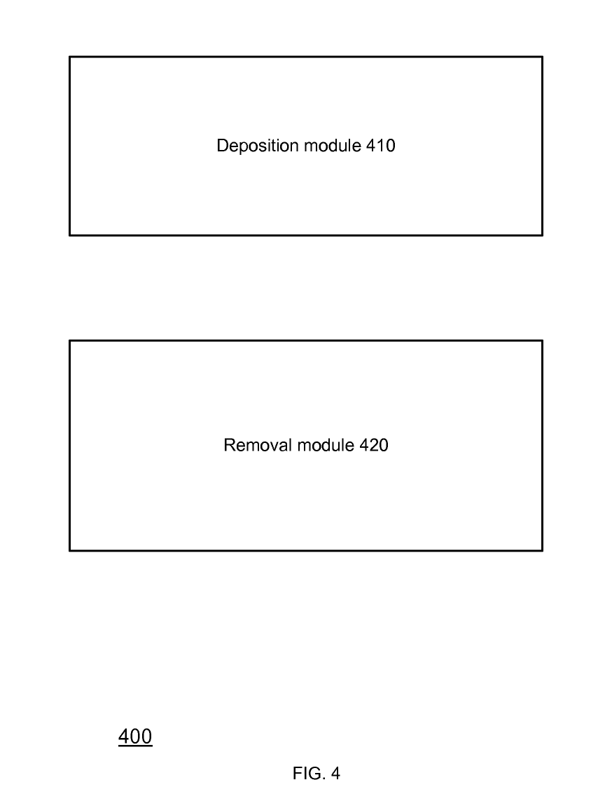

FIG. 4 illustrates a system 400 for reducing a contamination of a substrate. The system includes a deposition module 410 arranged to deposit protective material on an area of a substrate, to prevent the area from being contaminated by a coating material that is to be deposited during a deposition process. The deposition module 410 can be a printing head that includes multiple nozzles. The system may also include a removal module 420 arranged to remove the protective material from the area after the coating material was cured. The removal module 420 can be an ultrasonic tank.

The system 400 can execute any of the mentioned above methods.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

In the claims, the word ‘comprising’ does not exclude the presence of other elements or steps than those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

We claim:

1. A method for reducing a contaminations of a substrate , the method comprises:
depositing protective material on an area of a substrate, to prevent the area from being contaminated by a coating material that is to be deposited during a deposition process; and
removing the protective material from the area after the coating material was cured.

2. The method according to claim 1 wherein the area comprises portions that are expected to include contaminants and portions that are not expected to include contaminants.

3. The method according to claim 1 wherein the depositing of the protective material on the area causes the area to become hydrophobic.

4. The method according to claim 3, wherein the protective material is selected from a fatty acid, or a mixture of fatty acid and alcohol.

5. The method according to claim 1, wherein the area is made of copper and wherein the coating material is a solder mask ink.

6. The method according to claim 1, wherein the area is made of copper and wherein the coating material is an etch resist ink.

7. The method according to claim 1 wherein the protective material is an etch resist material and wherein the depositing comprises depositing the etch resist material on one or more areas to form a etch mask.

8. The method according to claim 1 comprising performing the deposition process; and curing the coating material that was deposited during the deposition process.

9. A method for cleaning a substrate, the method comprises:
cleaning at least one area of a substrate from a coating material, after the coating material was printed and cured; wherein the at least one area is expected to be substantially free from the coating material.

10. The method according to claim 9, comprising cleaning the at least area without damaging at least one pattern of the coating material that is formed on at least one other area.

11. The method according to claim 9, wherein the cleaning comprises placing the substrate within a ultrasonic tank that is filled with fluid and using to remove the contaminants.

12. The method according to claim 9, wherein the fluid comprises an acidic solution.

13. The method according to claim 9, wherein the fluid comprises an alkaline solution.

14. The method according to claim 9, wherein the coating material is a solder mask ink.

15. A system for reducing a contaminations of a substrate, the system comprises:
a deposition module arranged to deposit protective material on an area of a substrate, to prevent the area from being contaminated by a coating material that is to be deposited during a deposition process; and
a removal module arranged to remove the protective material from the area after the coating material was cured.
